(19) United States
(12) Patent Application Publication
(10) Pub. No.: US 2026/0188229 A1
(43) Pub. Date: Jul. 2, 2026

(54) DISPLAY DEVICE AND METHOD OF DRIVING THE SAME

(71) Applicant: LG Display Co., Ltd., Seoul (KR)

(72) Inventors: Dong Min LEE, Paju-si (KR); Chang Hee YOUN, Paju-si (KR); Han Seung YANG, Paju-si (KR); Gun Hee KU, Paju-si (KR)

(73) Assignee: LG Display Co., Ltd., Seoul (KR)

(21) Appl. No.: 19/428,894

(22) Filed: Dec. 22, 2025

(30) Foreign Application Priority Data
Dec. 31, 2024 (KR) 10-2024-0202764

(51) Int. Cl. G09G 3/3233

(52) U.S. Cl. CPC G09G 3/3233; G09G 2300/0426; G09G 2300/0819

(57) ABSTRACT

A display device and a method of driving the same are disclosed. The display device includes a light emitting element including an anode to which a driving current is applied and a cathode connected to a low-potential voltage line, a driving transistor configured to generate the driving current, a capacitor configured to store a data voltage for generating the driving current, and an initialization transistor configured to apply an initialization voltage to the anode of the light emitting element when the data voltage is a black data voltage for driving the light emitting element in black.

This application claims the benefit of Korean Patent Application No. 10-2024-0202764,

filed on Dec. 31, 2024, which is hereby incorporated by reference as if fully set forth herein.

### BACKGROUND

### Field of the Disclosure

The present disclosure relates to a display device and a method of driving the same.

### Discussion of the Related Art

An electroluminescent display device may display an image by including a plurality of subpixels and having a light emitting element of each subpixel emit light. The light emitting element may be implemented based on an organic or inorganic material.

A subpixel of the electroluminescent display device includes a light emitting element and a pixel circuit for driving the light emitting element. The pixel circuit may display an image by adjusting a driving current applied to the light emitting element.

In pixel circuits arranged in the display device, a voltage of a major node in a pixel may not be set to a desired initialization voltage due to effects such as parasitic capacitance and leakage current. In particular, when the light emitting element is implemented in a tandem structure by stacking a plurality of light emitting layers, an anode voltage of the light emitting element may fluctuate due to effects such as resistance asymmetry between the stacked light emitting layers or leakage current of adjacent light emitting elements.

Therefore, technology is needed to improve accuracy and stability of pixel operation by initializing the voltage of the major node in the pixel to a desired initialization voltage.

### SUMMARY

Accordingly, the present disclosure is directed to a display device and a method of driving the same that substantially obviate one or more problems due to limitations and disadvantages of the related art.

The embodiments disclosed in the present disclosure are intended to solve the above-mentioned problems and to provide a display device and a method of driving the same capable of improving accuracy and stability of pixel operation.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

To achieve these objects and other advantages and in accordance with the purpose of the disclosure, as embodied and broadly described herein, a display device includes a light emitting element including an anode to which a driving current is applied and a cathode connected to a low-potential voltage line, a driving transistor configured to generate the driving current, a capacitor configured to store a data voltage for generating the driving current, and an initialization transistor configured to apply an initialization voltage to the anode of the light emitting element when the data voltage is a black data voltage for driving the light emitting element in black.

When the data voltage is the black data voltage, the driving transistor may be turned off not to generate the driving current, and when the driving current is not generated, the light emitting element may be turned off and driven in black.

The driving transistor may be an n-channel transistor, and the initialization transistor may be a p-channel transistor.

The initialization transistor may include a gate electrode configured to receive input of the data voltage, a first electrode connected to the anode, and a second electrode connected to the cathode.

The initialization transistor may include a gate electrode configured to receive input of the data voltage, a first electrode connected to the anode, and a second electrode connected to an initialization voltage line configured to apply the initialization voltage to the anode.

The initialization transistor may include a gate electrode configured to receive input of the data voltage, a first electrode connected to the anode, and a second electrode connected to a reference voltage line configured to apply a reference voltage to the anode.

The display device may further include a first switching transistor having a gate electrode connected to a first scan line, a first electrode connected to a first data line, and a second electrode connected to a gate node of the driving transistor, a second switching transistor having a gate electrode connected to a second scan line, a first electrode connected to a reference voltage line, and a second electrode connected to the gate node of the driving transistor, and a capacitor having a first electrode connected to the second electrode of the first switching transistor and the gate node of the driving transistor, and a second electrode connected to a source node of the driving transistor.

The display device may further include a first switching transistor having a gate electrode connected to a first scan line, a first electrode connected to a first data line, and a second electrode connected to a gate node of the driving transistor, a second switching transistor having a gate electrode connected to a second scan line, a first electrode connected to a reference voltage line, and a second electrode connected to the gate node of the driving transistor, a third switching transistor having a gate electrode connected to a third scan line and a first electrode connected to an initialization voltage line, a first light emitting transistor having a gate electrode connected to a first light emission line, a first electrode connected to a high-potential voltage line, and a second electrode connected to a drain node of the driving transistor, a second light emitting transistor having a gate electrode connected to a second light emission line, a first electrode connected to a source node of the driving transistor, and a second electrode connected to the anode of the light emitting element, and a capacitor having a first electrode connected to the second electrode of the first switching transistor and the gate node of the driving transistor, and a second electrode connected to the source node of the driving transistor.

In another aspect of the present disclosure, a display device includes a light emitting element comprising an anode to which a driving current is applied and a cathode connected to a low-potential voltage line, a driving transistor configured to generate the driving current, a capacitor configured to store a first data voltage for generating the driving current, and an initialization transistor configured to be turned on based on a second data voltage and to apply an initialization voltage to the anode of the light emitting element.

In another aspect of the present disclosure, a method of driving a display device includes a first initialization operation of initializing a gate node and a source node of a driving transistor based on a reference voltage and an initialization voltage, a sampling operation of storing a sampling value of the driving transistor in a capacitor based on a high-potential voltage and the reference voltage, a data writing operation of storing a data voltage in the capacitor by summing the data voltage with the sampling value stored in the capacitor, a reset operation of initializing the source node of the driving transistor and an anode of a light emitting element based on the initialization voltage, and a light emitting operation of causing the light emitting element to emit light based on a driving current generated from the driving transistor, wherein the method further includes a second initialization operation of initializing the anode of the light emitting element when the data voltage is a black data voltage for driving the light emitting element in black in the data writing operation.

The second initialization operation may include applying any one of a low-potential voltage, the reference voltage, and the initialization voltage to the anode of the light emitting element.

It is to be understood that both the foregoing general description and the following detailed description of the present disclosure are by way of example and explanatory and are intended to provide further explanation of the disclosure as claimed.

### BRIEF DESCRIPTION OF THE DRAWINGS

The accompanying drawings, which are included to provide a further understanding of the present disclosure and are incorporated in and constitute a part of this application, illustrate example embodiment(s) of the present disclosure and together with the description serve to explain various principles of the disclosure. In the drawings:

FIG. 1 is a block diagram schematically illustrating an example configuration of a display device;

FIG. 2 is a circuit diagram of a subpixel included in a display device according to a first example embodiment of the present disclosure;

FIG. 3 is a driving waveform diagram of the subpixel included in the display device according to the first example embodiment of the present disclosure;

FIGS. 4 to 8 are diagrams each illustrating an operating state of the subpixel according to a driving waveform of FIG. 3;

FIG. 9 is a circuit diagram illustrating an anode initialization operation of the subpixel included in the display device according to the first example embodiment of the present disclosure;

FIG. 10 is a circuit diagram illustrating an anode initialization operation of a subpixel included in a display device according to a second example embodiment of the present disclosure;

FIG. 11 is a circuit diagram illustrating an anode initialization operation of a subpixel included in a display device according to a third example embodiment of the present disclosure;

FIG. 12 is a circuit diagram illustrating an anode initialization operation of a subpixel included in a display device according to a fourth example embodiment of the present disclosure; and

FIGS. 13 and 14 are graphs each illustrating a result of simulating changes in a gate node voltage and a source node (anode) voltage of a driving transistor during black driving of each of a display device according to an example embodiment of the present disclosure and a display device according to a comparative example.

### DETAILED DESCRIPTION

Advantages and features of the present disclosure and a method of achieving the advantages and features will become clear with reference to the example embodiments described in detail below together with the accompanying drawings. However, the present disclosure is not limited to the example embodiments disclosed below and may be implemented in various different forms, and the example embodiments are provided only to make the description of the present disclosure more complete and to inform a person having ordinary skill in the art to which the present disclosure pertains of the scope of the present disclosure more fully.

The shapes, sizes, ratios, angles, numbers, etc., disclosed in the drawings to describe the example embodiments of the present disclosure are illustrative, and thus the present disclosure is not limited to the illustrated examples. The same reference numerals refer to the same components throughout the specification. Where terms like “include,” “have,” and “comprise,” etc., are used in the present disclosure, other parts may be added unless a more specific term like “only” is used. Where a component is expressed in a singular form, this includes the case where the component is plural unless otherwise specified.

In interpreting a component, the component is to be interpreted as including an error range even if there is no separate explicit description.

Where a positional relationship is described, for example, where a positional relationship between two parts is described as “on,” “above,” “below,” “next to,” etc., one or more other parts may be located between the two parts, unless a more specific term like “immediately” or “directly” is used.

Even though terms like first, second, etc., may be used to describe various components, these components are not limited by these terms. These terms are only used to refer to one component separately from another. Thus, a first component mentioned below may be a second component, and vice versa, within the technical concept of the present disclosure.

In addition, a pixel circuit of a display device described below may include a plurality of transistors. The transistors may be implemented as an oxide thin film transistor (TFT) including an oxide semiconductor, an LTPS TFT including low temperature poly silicon (LTPS), etc. Each of the transistors may be implemented as a p-channel TFT or an n-channel TFT.

A transistor is a three-electrode device that includes a gate, a source, and a drain. The source is an electrode that supplies carriers to the transistor. Inside the transistor, carriers start to flow from the source. The drain is an electrode through which carriers exit the transistor. In the transistor, carriers flow from the source to the drain. In the case of an n-channel transistor, since the carriers are electrons, a source voltage is lower than a drain voltage so that electrons may flow from the source to the drain. In the n-channel transistor, current flows in a direction from the drain to the source. In the case of a p-channel transistor (PMOS), since the carriers are holes, the source voltage is higher than the drain voltage so that the holes may flow from the source to the drain. In the p-channel transistor, since holes flow from the source to the drain, current flows from the source to the drain. It should be noted that the source and the drain of the transistor are not fixed. For example, the source and the drain may be switched depending on the applied voltage. Therefore, the disclosure is not limited by the source and the drain of the transistor. In the following description, the source and the drain of the transistor may be referred to as first and second electrodes.

A gate signal swings between a gate-on-voltage and a gate-off-voltage. The gate-on-voltage is set to a voltage higher than a threshold voltage of the transistor, and the gate-off-voltage is set to a voltage lower than the threshold voltage of the transistor. The transistor turns on in response to the gate-on-voltage and turns off in response to the gate-off-voltage. In the n-channel transistor, the gate-on-voltage may be a gate-high-voltage (VGH), and the gate-off-voltage may be a gate-low-voltage (VGL). In the p-channel transistor, the gate-on-voltage may be a VGL, and the gate-off-voltage may be a VGH.

Throughout the specification, the same reference numerals refer to substantially the same components. Hereinafter, example embodiments of the present disclosure will be described in detail with reference to the attached drawings. In the following description, where a detailed description of a known function or configuration related to the present disclosure may unnecessarily obscure a feature or aspect of the present disclosure, the detailed description may be omitted.

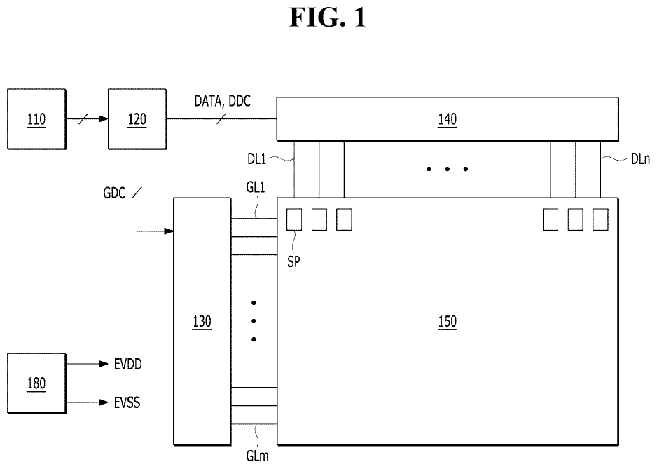

FIG. 1 is a block diagram schematically illustrating an example configuration of a display device.

As shown in FIG. 1, the display device may include an image supply unit 110, a timing controller 120, a gate driver 130, a data driver 140, a display panel 150, a power supply 180, etc.

An image supply unit 110 may output various driving signals in addition to an image data signal supplied from the outside or an image data signal stored in an internal memory. The image supply unit 110 may supply data signals and various driving signals to the timing controller 120.

The timing controller 120 may output a gate timing control signal GDC for controlling the operation timing of the gate driver 130, a data timing control signal DDC for controlling the operation timing of the data driver 140, various synchronization signals (Vsync, which is a vertical synchronization signal, and Hsync, which is a horizontal synchronization signal), etc. The timing controller 120 may supply a data signal DATA supplied from the image supply unit 110 together with the data timing control signal DDC to the data driver 140. The timing controller 120 may be formed as an IC (Integrated Circuit) and mounted on a printed circuit board, but the present disclosure is not limited thereto.

The gate driver 130 may output a gate signal (or gate voltage) in response to the gate timing control signal GDC supplied from the timing controller 120. The gate driver 130 may supply the gate signal to subpixels SP included in the display panel 150 through gate lines GL1 to GLm. The gate driver 130 may be formed as an IC or directly formed on the display panel 150 in a gate-in-panel (GIP) manner, but the present disclosure is not limited thereto.

The data driver 140 may sample and latch the data signal DATA in response to the data timing control signal DDC supplied from the timing controller 120, convert a digital data signal into an analog data voltage based on a gamma reference voltage, and output the analog data voltage. The data driver 140 may supply a data voltage to subpixels included in the display panel 150 through data lines DL1 to DLn. The data driver 140 may be formed as an IC and mounted on the display panel 150 or on a printed circuit board, but the present disclosure is not limited thereto.

The power supply 180 may generate a high-potential voltage and a low-potential voltage based on an external input voltage supplied from the outside, and output the generated voltages through a high-potential voltage line EVDD and a low-potential voltage line EVSS. The power supply 180 may generate and output not only the high-potential voltage and the low-potential voltage, but also a voltage for driving the gate driver 130 or a voltage for driving the data driver 140.

In the display panel 150, a plurality of data lines DL1 to DLn extending in a column direction (or vertical direction) and a plurality of gate lines GL1 to GLm extending in a row direction (or horizontal direction) intersect, and subpixels SPs are arranged in a matrix at respective intersection regions to form a pixel array. Subpixels SPs arranged in the same pixel line simultaneously operate according to a scan signal and an emission signal applied from the same gate line GL. Each subpixel SP includes a light emitting element and a pixel circuit that controls the amount of current applied to an anode of the light emitting element. The pixel circuit may include a driving transistor that controls the amount of current so that a constant amount of current may flow to the light emitting element.

Meanwhile, in the above description, the timing controller 120, the gate driver 130, the data driver 140, etc. are described as individual components. However, depending on the implementation method of the display device, one or more of the timing controller 120, the gate driver 130, and the data driver 140 may be integrated into one IC.

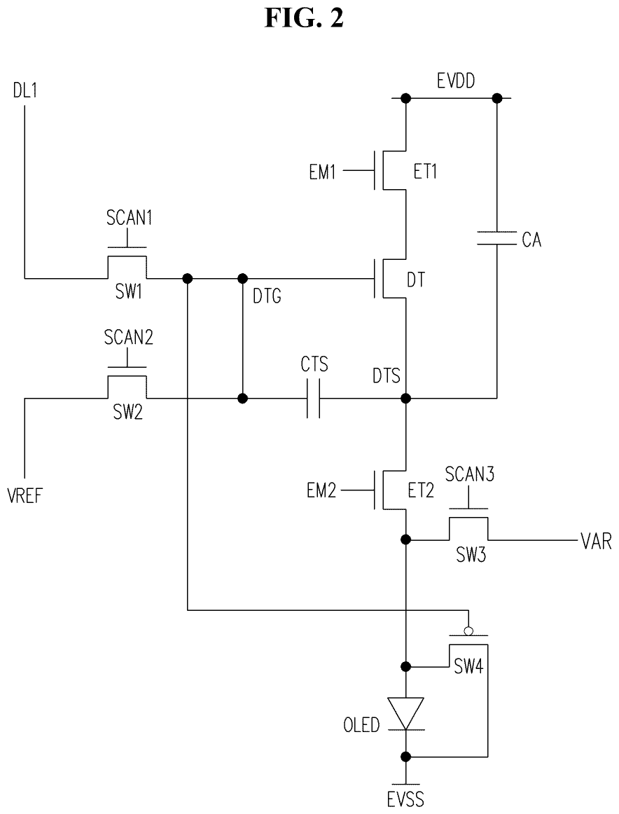

FIG. 2 is a circuit diagram of a subpixel according to an example embodiment of the present disclosure.

As shown in FIG. 2, a subpixel according to an example embodiment may include a first switching transistor SW1, a second switching transistor SW2, a third switching transistor SW3, a fourth switching transistor SW4, a first light emitting transistor ET1, a second light emitting transistor ET2, a driving transistor DT, a first capacitor CTS, a second capacitor CA, and a light emitting diode OLED.

The first switching transistor SW1 may have a gate electrode connected to a first scan line SCAN1, a first electrode connected to a first data line DL1, and a second electrode connected to a gate node DTG of the driving transistor DT (or a gate electrode of the driving transistor). The first switching transistor SW1 may transmit a data voltage (or first data voltage) applied through the first data line DL1 to the gate node DTG of the driving transistor DT in response to a first scan signal applied through the first scan line SCAN1.

The second switching transistor SW2 may have a gate electrode connected to a second scan line SCAN2, a first electrode connected to a reference voltage line VREF, and a second electrode connected to the gate node DTG of the driving transistor DT (or the gate electrode of the driving transistor). The second switching transistor SW2 may transmit a reference voltage applied through the reference voltage line VREF to the gate node DTG of the driving transistor DT in response to a second scan signal applied through the second scan line SCAN2.

The third switching transistor SW3 may have a gate electrode connected to a third scan line SCAN3, a first electrode connected to an initialization voltage line VAR, and a second electrode connected to a second electrode of the second light emitting transistor ET2 and an anode of the light emitting diode OLED. The third switching transistor SW3 may transmit an initialization voltage applied through the initialization voltage line VAR to the anode of the light emitting diode OLED in response to a third scan signal applied through the third scan line SCAN3.

The fourth switching transistor SW4 may operate as an initialization transistor that applies an initialization voltage to the anode of the light emitting diode OLED. The fourth switching transistor SW4 may have a gate electrode connected to the gate node DTG, a first electrode connected to the anode of the light emitting diode OLED, and a second electrode connected to a cathode of the light emitting diode OLED. The fourth switching transistor SW4 may be turned on in response to a data voltage applied to the gate node DTG. When the fourth switching transistor SW4 is turned on, the anode and the cathode of the light emitting diode OLED are interconnected, so that the anode may be initialized to a low-potential voltage of the cathode supplied to the low-potential voltage line EVSS. The fourth switching transistor SW4 may be designed to be turned on when black data for driving the subpixel in black is input. The black data is data set so that the subpixel implements a black gradation, and may be set to a voltage level at which the driving transistor DT for supplying driving current to the light emitting diode OLED may be maintained in an off state. For example, when the driving transistor DT is an n-channel transistor NMOS, the black data is set to have a logic low voltage, and the fourth switching transistor SW4 may be implemented as a p-channel transistor PMOS that is turned on by receiving the logic low voltage. Accordingly, when the black data is input, the fourth switching transistor SW4 is turned on so that the anode of the light emitting diode OLED may be initialized to a low-potential voltage supplied to the low-potential voltage line EVSS. Meanwhile, the above description provides an example embodiment in which the anode of the light emitting diode OLED is initialized to the low-potential voltage supplied to the low-potential voltage line EVSS when the black data is input. However, the present disclosure is not limited thereto, and various voltages capable of initializing the anode among power supplied to the subpixel, such as initialization voltage and reference voltage, may be applied.

The first light emitting transistor ET1 may have a gate electrode connected to a first light emission line EM1, a first electrode connected to the high-potential voltage line EVDD, and a second electrode connected to a drain node of the driving transistor DT (or the first electrode of the driving transistor). The first light emitting transistor ET1 may transmit a high-potential voltage applied through the high-potential voltage line EVDD to the drain node of the driving transistor DT (or the first electrode of the driving transistor) in response to a first emission signal applied through the first light emission line EM1.

The second light emitting transistor ET2 may have a gate electrode connected to a second light emission line EM2, a first electrode connected to a source node DTS of the driving transistor DT (or the second electrode of the driving transistor), and a second electrode connected to the anode of the light emitting diode OLED. The second light emitting transistor ET2 may transmit a driving current generated from the driving transistor DT to the anode of the light emitting diode OLED in response to a second emission signal applied through the second light emission line EM2.

The driving transistor DT may have a gate electrode connected to the second electrode of the first switching transistor SW1, the second electrode of the second switching transistor SW2, and a first electrode of the first capacitor CTS, a first electrode connected to the second electrode of the first light emitting transistor ET1, and a second electrode connected to the first electrode of the second light emitting transistor ET2. The driving transistor DT operates based on a data voltage stored in the first capacitor CTS and may generate a driving current. When the data voltage is a black data voltage for driving the light emitting diode OLED in black, the driving transistor DT may be turned off not to generate the driving current, and when the driving current is not generated, the light emitting diode OLED may be turned off and driven in black.

The first capacitor CTS may have a first electrode connected to the second electrode of the first switching transistor SW1, the second electrode of the second switching transistor SW2, the gate node DTG of the driving transistor DT (or the gate electrode of the driving transistor), and a gate node of the fourth switching transistor SW4, and a second electrode connected to the source node DTS of the driving transistor DT (or the second electrode of the driving transistor) and a second electrode of the second capacitor CA. The first capacitor CTS may perform a sampling operation based on a reference voltage transmitted through the second switching transistor SW2 to store a sampling value, and may store a data voltage transmitted through the first switching transistor SW1. The first capacitor CTS may be defined as a capacitor for storing a data voltage for generating a driving current.

The second capacitor CA may have a first electrode connected to the high-potential voltage line EVDD and a second electrode connected to the source node DTS of the driving transistor DT (or the second electrode of the driving transistor). The second capacitor CA may prevent or suppress the source node DTS of the driving transistor DT from becoming unstable or stabilize the source node DTS of the driving transistor DT during a light emitting operation of the subpixel. The second capacitor CA may be defined as a driving stabilization capacitor.

The light emitting diode OLED may have the anode connected to the second electrode of the second light emitting transistor ET2 and the second electrode of the third switching transistor SW3, and the cathode connected to the low-potential voltage line EVSS. The light emitting diode OLED may emit light based on the driving current of the driving transistor DT transmitted through the second light emitting transistor ET2.

In the subpixel according to the example embodiment having the above configuration, the fourth switching transistor SW4 may be a p-channel transistor PMOS, and the remaining transistors may all be implemented as n-channel transistors NMOS. That is, the first to third switching transistors SW1 to SW3, the first light emitting transistor ET1, the second light emitting transistor ET2, and the driving transistor DT may be n-channel transistors NMOS, and the fourth switching transistor SW4 may be implemented as a p-channel transistor PMOS. However, the configuration of the subpixel according to the above embodiment is only an example, and the present disclosure is not limited thereto. The configuration may be modified to another form including the fourth switching transistor SW4 that receives a black data voltage (or second data voltage) for turning off the driving transistor DT and applies an initialization voltage to the anode of the light emitting diode OLED.

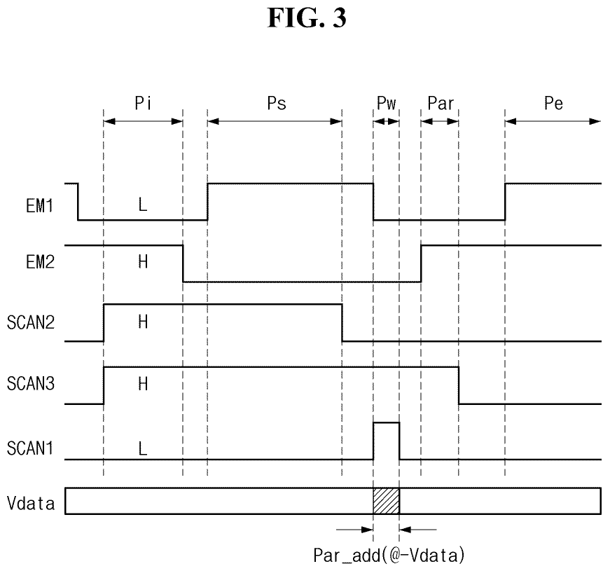

FIG. 3 is a driving waveform diagram for driving the subpixel illustrated in FIG. 2.

As illustrated in FIG. 3, a driving period of the subpixel according to the example embodiment may include an initialization period Pi, a sampling period Ps, a data writing period Pw, a first reset period Par, and an emission period Pe, and may further include a second reset period Par_add when data written in the data writing period Pw is black data-Vdata.

During the initialization period Pi, a first emission signal EM1 may be applied as a low voltage L, a second emission signal EM2 may be applied as a high voltage H, a first scan signal SCAN1 may be applied as a low voltage L, and a second scan signal SCAN2 and a third scan signal SCAN3 may be applied as a high voltage H.

During the sampling period Ps, the first emission signal EM1 may be applied as a high voltage H, the second emission signal EM2 may be applied as a low voltage L, the first scan signal SCAN1 may be applied as a low voltage L, and the second scan signal SCAN2 and the third scan signal SCAN3 may be applied as a high voltage H.

During the data writing period Pw, the first emission signal EM1 and the second emission signal EM2 may be applied as a low voltage L, the first scan signal SCAN1 and the third scan signal SCAN3 may be applied as a high voltage H, and the second scan signal SCAN2 may be applied as a low voltage L.

During the first reset period Par, the first emission signal EM1 may be applied as a low voltage L, the second emission signal EM2 may be applied as a high voltage H, the first scan signal SCAN1 and the second scan signal SCAN2 may be applied as a low voltage L, and the third scan signal SCAN3 may be applied as a high voltage H.

During the emission period Pe, the first emission signal EM1 and the second emission signal EM2 may be applied as a high voltage H, and the first scan signal SCAN1 to the third scan signal SCAN3 may be applied as a low voltage L.

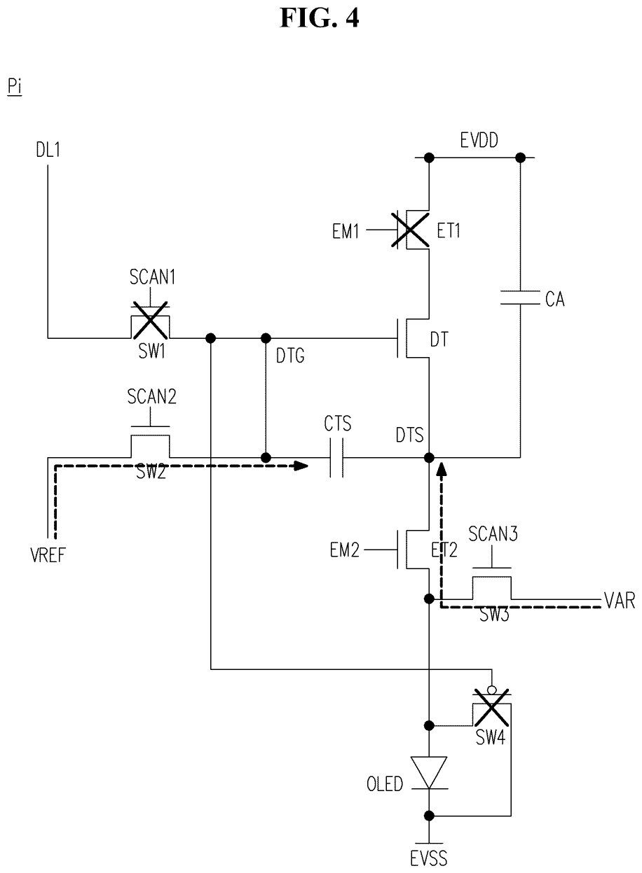

FIGS. 4 to 8 are diagrams each illustrating an operating state of the subpixel according to a driving waveform of FIG. 3.

FIG. 4 is a diagram illustrating an operation of the subpixel in the initialization period Pi.

As shown in FIGS. 4 and 3, during the initialization period Pi, the second emission signal EM2, the second scan signal SCAN2, and the third scan signal SCAN3 may be applied as a high voltage H. In response thereto, the second switching transistor SW2, the third switching transistor SW3, and the second light emitting transistor ET2 may be turned on during the initialization period Pi. The first switching transistor SW1, the fourth switching transistor SW4, the first light emitting transistor ET1, and the driving transistor DT may be turned off.

During the initialization period Pi, as the second switching transistor SW2, the third switching transistor SW3, and the second light emitting transistor ET2 are turned on, the gate node DTG and the source node DTS of the driving transistor DT may be initialized based on the reference voltage and the initialization voltage. This process may be called as a first initialization step.

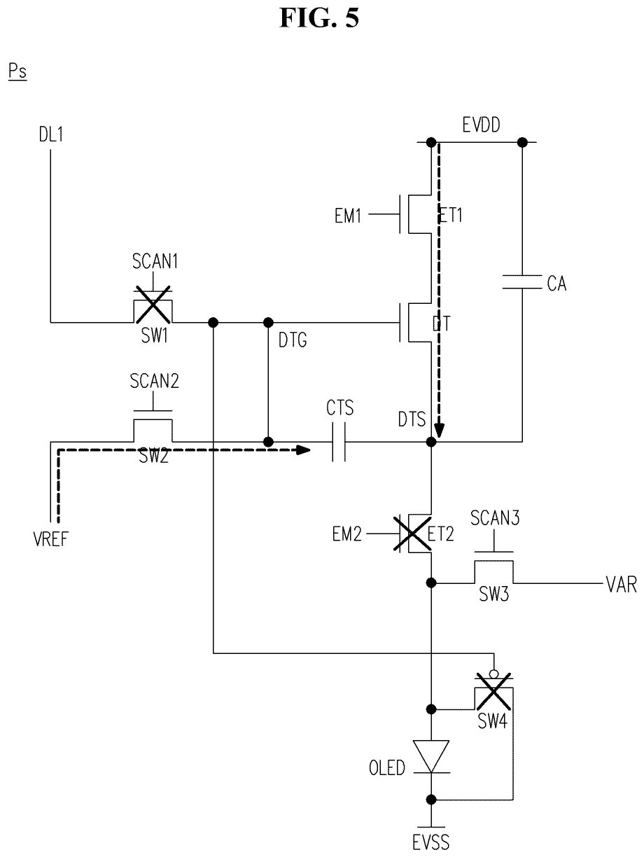

FIG. 5 is a diagram illustrating an operation of the subpixel during the sampling period Ps.

As shown in FIG. 5 and FIG. 3, during the sampling period Ps, the first emission signal EM1, the second scan signal SCAN2, and the third scan signal SCAN3 may be applied as a high voltage H. In response thereto, the second switching transistor SW2, the third switching transistor SW3, and the first light emitting transistor ET1 may be turned on during the sampling period Ps. The first switching transistor SW1, the fourth switching transistor SW4, and the second light emitting transistor ET2 may be turned off.

When the first light emitting transistor ET1 is turned on during the sampling period Ps and a high potential voltage is applied to the driving transistor DT, the first capacitor CTS may store a sampled value of the driving transistor DT, for example, a sampled value of a threshold voltage of the driving transistor DT based on the reference voltage and the high potential voltage. This process may be called a sampling step.

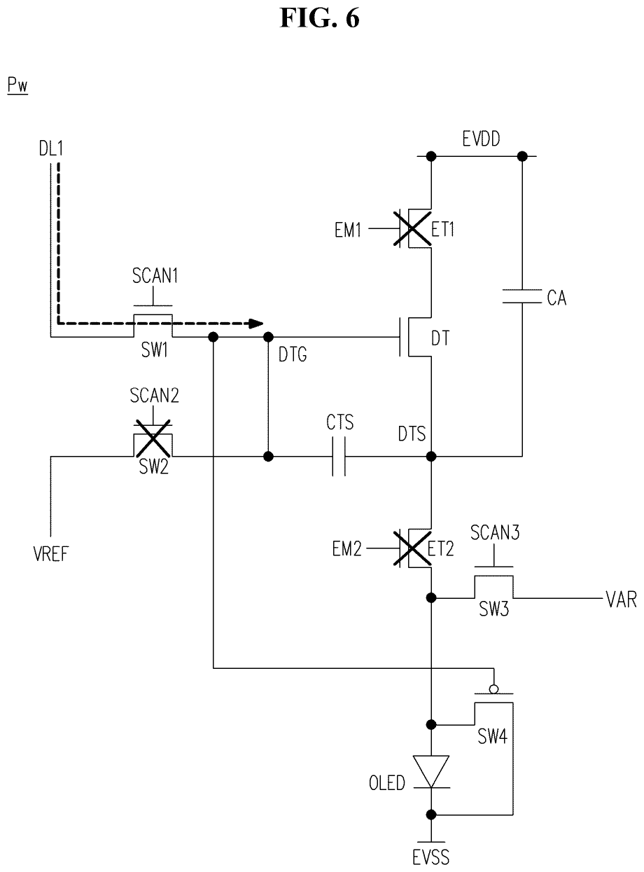

FIG. 6 is a diagram illustrating an operation of the subpixel during the data writing period Pw.

As shown in FIG. 6 and FIG. 3, during the data writing period Pw, the first scan signal SCAN1 and the third scan signal SCAN3 may be applied as a high voltage H. In response thereto, the first switching transistor SW1 and the third switching transistor SW3 may be turned on during the data writing period Pw. The second switching transistor SW2, the first light emitting transistor ET1, the second light emitting transistor ET2, and the driving transistor DT may be turned off.

During the data writing period Pw, as the first switching transistor SW1 is turned on, a data voltage applied through the first data line DL1 may be stored in a first capacitor CTS by summing the data voltage with the sampling value stored in the first capacitor CTS. This process may be called as a data writing step.

Here, the fourth switching transistor SW4 may be turned on or turned off depending on the voltage level of the data voltage applied to the gate node DTG. When the data voltage is input as a black data voltage that drives the subpixel in black, the fourth switching transistor SW4 may be turned on, and in other cases, the fourth switching transistor SW4 may be maintained in a turn-off state. Driving of the fourth switching transistor SW4 during the data writing period Pw will be described in more detail later.

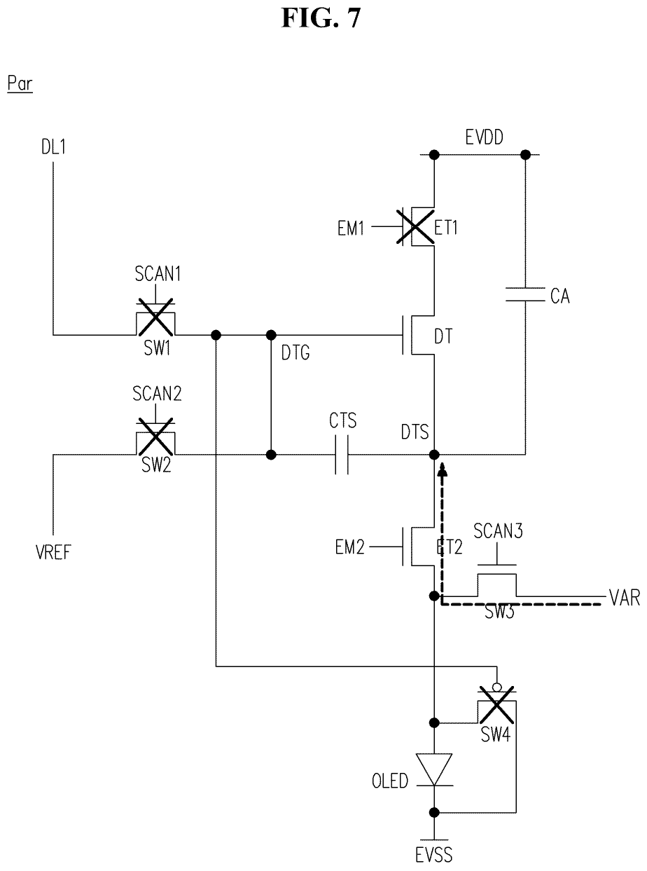

FIG. 7 is a diagram illustrating an operation of the subpixel during the first reset period Par.

As shown in FIG. 7 and FIG. 3, during the first reset period Par, the second emission signal EM2 and the third scan signal SCAN3 may be applied as a high voltage H. In response thereto, the second light emitting transistor ET2 and the third switching transistor SW3 may be turned on during the first reset period Par. The first switching transistor SW1, the second switching transistor SW2, the fourth switching transistor SW4, the first light emitting transistor ET1, and the driving transistor DT may be turned off.

During the first reset period Par, as the second light emitting transistor ET2 and the third switching transistor SW3 are turned on, the source node DTS of the driving transistor DT and the anode of the light emitting diode OLED may be initialized based on the initialization voltage. This process may be called as a reset step.

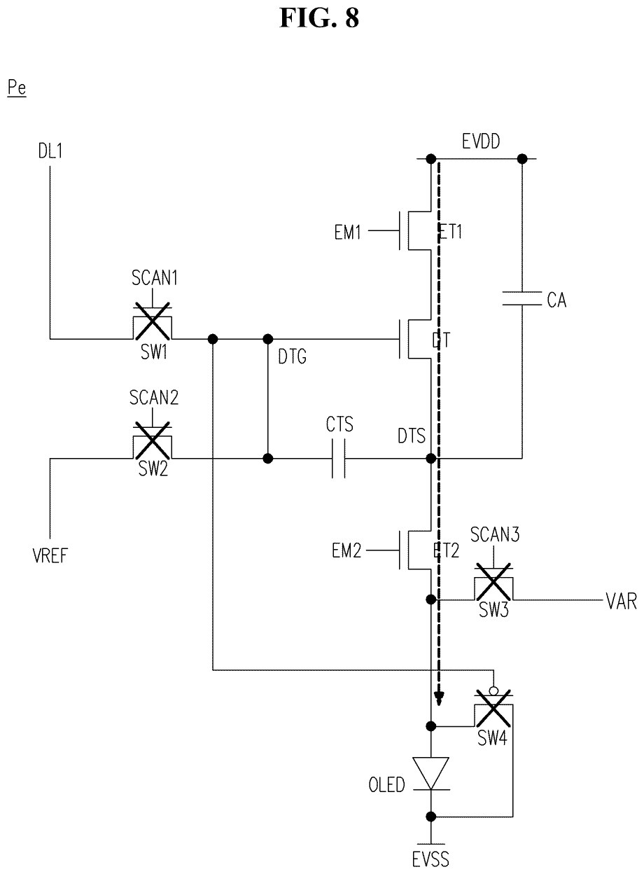

FIG. 8 is a diagram illustrating an operation of the subpixel during the emission period Pe.

As shown in FIG. 8 and FIG. 3, during the emission period Pe, the first emission signal EM1 and the second emission signal EM2 may be applied as a high voltage H. In response thereto, the first light emitting transistor ET1, the second light emitting transistor ET2, and the driving transistor DT may be turned on during the emission period Pe. The first switching transistor SW1 to the fourth switching transistor SW4 may be turned off.

As the first light emitting transistor ET1 and the second light emitting transistor ET2 are turned on during the emission period Pe, the light emitting diode OLED may emit light in response to the driving current generated from the driving transistor DT. This process may be called as a light emitting step.

Meanwhile, the fourth switching transistor SW4 may be turned on or off depending on the data voltage applied through the first data line DL1 during the data writing period Pw. When the data voltage is input as a black data voltage that drives the subpixel in black in the data writing step, the fourth switching transistor SW4 may be turned on. When the fourth switching transistor SW4 is turned on, a voltage of power supplied to the subpixel that may initialize the anode of the light emitting diode OLED, such as a low-potential voltage, a initialization voltage, or a reference voltage, may be applied to the anode of the light emitting diode OLED. This process may be called as a second initialization step.

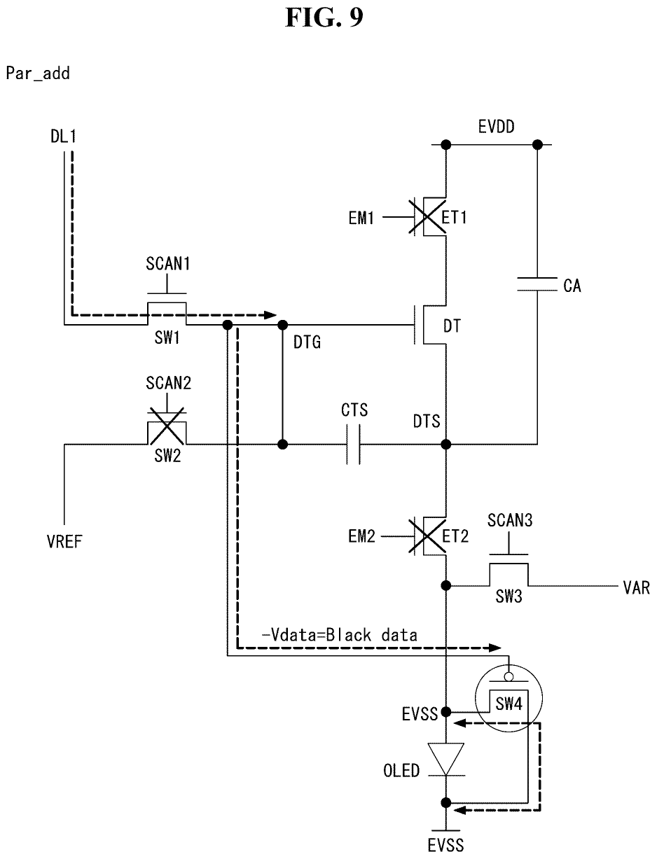

FIGS. 9 to 12 are drawings for describing example embodiments of the fourth switching transistor SW4 that initializes the anode of the light emitting diode OLED in response to a black data voltage-Vdata during the data writing period Pw.

FIG. 9 is a circuit diagram illustrating an anode initialization operation of a subpixel included in a display device according to a first example embodiment of the present disclosure.

In the display device according to the first example embodiment, a fourth switching transistor SW4 may have a gate electrode connected to a gate node DTG, a first electrode connected to an anode of a light emitting diode OLED, and a second electrode connected to a cathode of the light emitting diode OLED.

The fourth switching transistor SW4 may be turned on in response to a black data voltage-Vdata applied to the gate node DTG during a data writing period Pw. When the fourth switching transistor SW4 is turned on, the anode and the cathode of the light emitting diode OLED are interconnected, so that the anode may be initialized to a low-potential voltage of the cathode supplied to a low-potential voltage line EVSS.

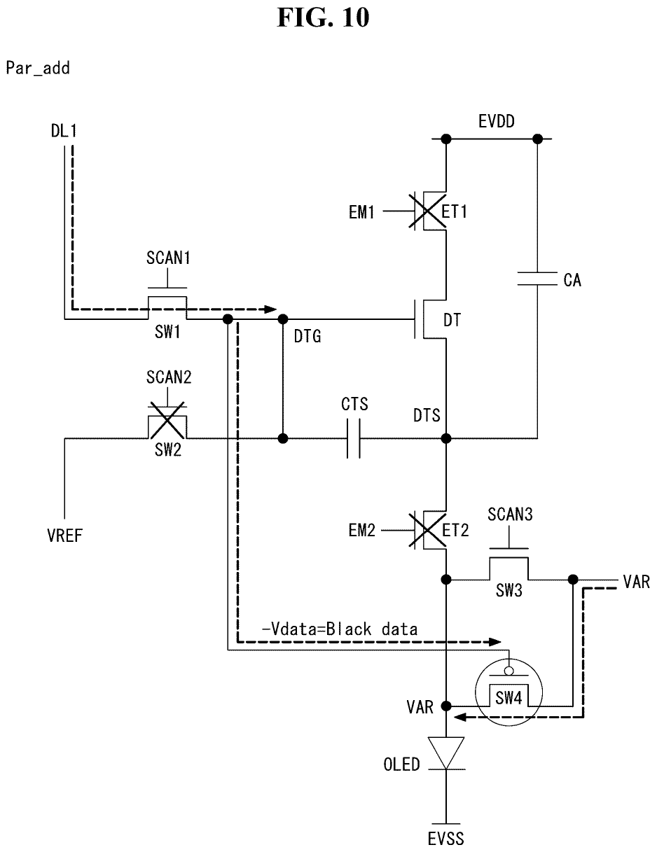

FIG. 10 is a circuit diagram illustrating an anode initialization operation of a subpixel included in a display device according to a second example embodiment of the present disclosure.

In the display device according to the second example embodiment, a fourth switching transistor SW4 may have a gate electrode connected to a gate node DTG, a first electrode connected to an anode of a light emitting diode OLED, and a second electrode connected to an initialization voltage line VAR.

The fourth switching transistor SW4 may be turned on in response to a black data voltage-Vdata applied to the gate node DTG during a data writing period Pw. When the fourth switching transistor SW4 is turned on, an initialization voltage supplied to the initialization voltage line VAR is applied to the anode of the light emitting diode OLED. Accordingly, the anode of the light emitting diode OLED may be initialized to the initialization voltage.

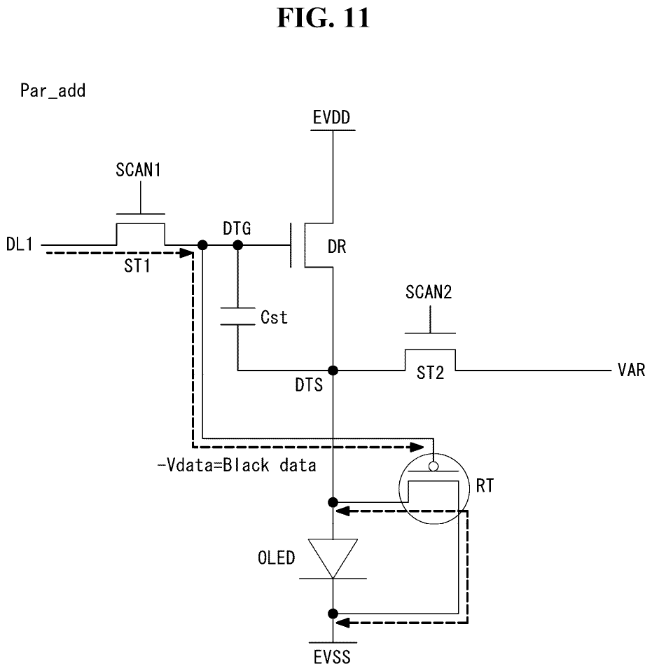

FIG. 11 is a circuit diagram illustrating an anode initialization operation of a subpixel included in a display device according to a third example embodiment of the present disclosure. The third example embodiment is a subpixel including a reset transistor RT that has the same function as that of the fourth switching transistor SW4 of the first example embodiment, and illustrates a case where a subpixel structure is different from that of the first example embodiment.

In the display device according to the third example embodiment, one subpixel includes a switching transistor ST1, a sensing transistor ST2, a driving transistor DR, a capacitor Cst, and an organic light emitting diode OLED, and may include a reset transistor RT that has the same function as that of the fourth switching transistor SW4 of the first and second example embodiments.

The driving transistor DR may have a gate node DTG connected to a first electrode of the capacitor Cst, a first electrode connected to a first power line EVDD, and a second electrode connected to a source node DTS.

The capacitor Cst may have a first electrode connected to the gate node DTG of the driving transistor DR, and a second electrode connected to the source node DTS.

The organic light emitting diode OLED may have an anode connected to the source node DTS of the driving transistor DR, and a cathode connected to a second power line EVSS.

The switching transistor ST1 may have a gate electrode connected to an input line of a first scan signal SCAN1, a first electrode connected to a first data line DL1, and a second electrode connected to the gate node DTG of the driving transistor DT. The switching transistor ST1 may be turned on by the first scan signal SCAN1 and may apply the data voltage input to the first data line DL1 to the gate node DTG of the driving transistor DT.

The sensing transistor ST2 may have a gate electrode connected to an input line of a second scan signal SCAN2, a first electrode connected to a reference line VREF, and a second electrode connected to the source node DTS which is a sensing node. The sensing transistor ST2 may acquire a sensing value through the source node DTS defined between the driving transistor DR and the organic light emitting diode OLED.

The reset transistor RT may have a gate electrode connected to the gate node DTG, a first electrode connected to the anode of the light emitting diode OLED, and a second electrode connected to the cathode of the light emitting diode OLED.

The reset transistor RT may be turned on in response to a black data voltage-Vdata applied to the gate node DTG. When the reset transistor RT is turned on, the anode and the cathode of the light emitting diode OLED are interconnected, so that the anode may be initialized to a low-potential voltage of the cathode supplied to a low-potential voltage line EVSS.

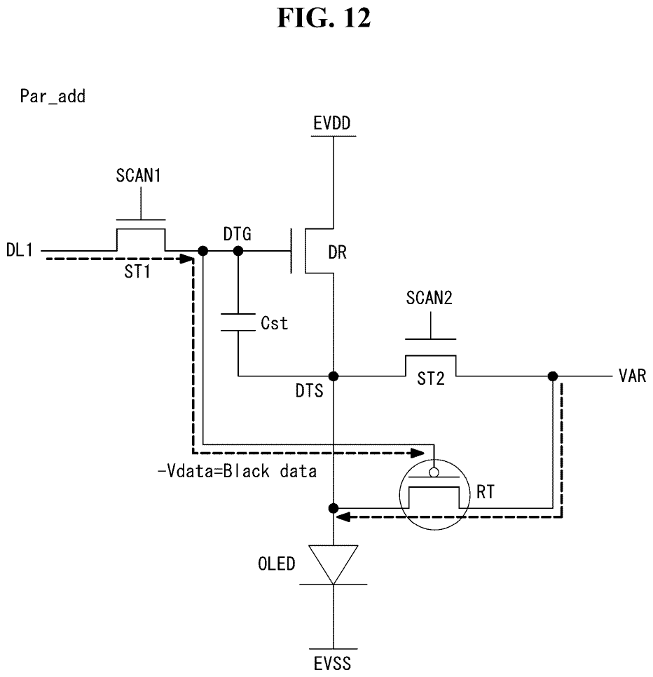

FIG. 12 is a circuit diagram illustrating an anode initialization operation of a subpixel included in a display device according to a fourth example embodiment of the present disclosure. The fourth example embodiment illustrates a case where a connection structure of the reset transistor RT is changed in a subpixel structure of the third example embodiment.

In the subpixel of the display device according to the fourth example embodiment, a connection structure of the switching transistor ST1, the sensing transistor ST2, the driving transistor DR, the capacitor Cst, and the organic light emitting diode OLED is the same as that of the subpixel of the third example embodiment, and thus a detailed description thereof will be omitted.

In the subpixel of the display device according to the fourth example embodiment, the reset transistor RT may have a gate electrode connected to a gate node DTG, a first electrode connected to an anode of the light emitting diode OLED, and a second electrode connected to an initialization voltage line VAR.

The reset transistor RT may be turned on in response to a black data voltage-Vdata applied to the gate node DTG. When the reset transistor RT is turned on, an initialization voltage supplied through an initialization voltage line VAR is applied to the anode of the light emitting diode OLED. Accordingly, the anode of the light emitting diode OLED may be initialized to the initialization voltage.

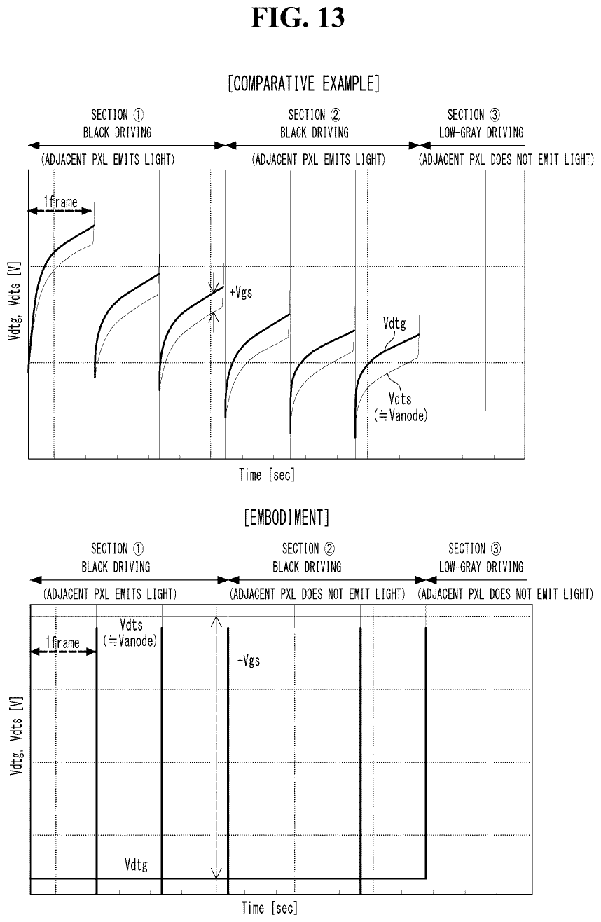

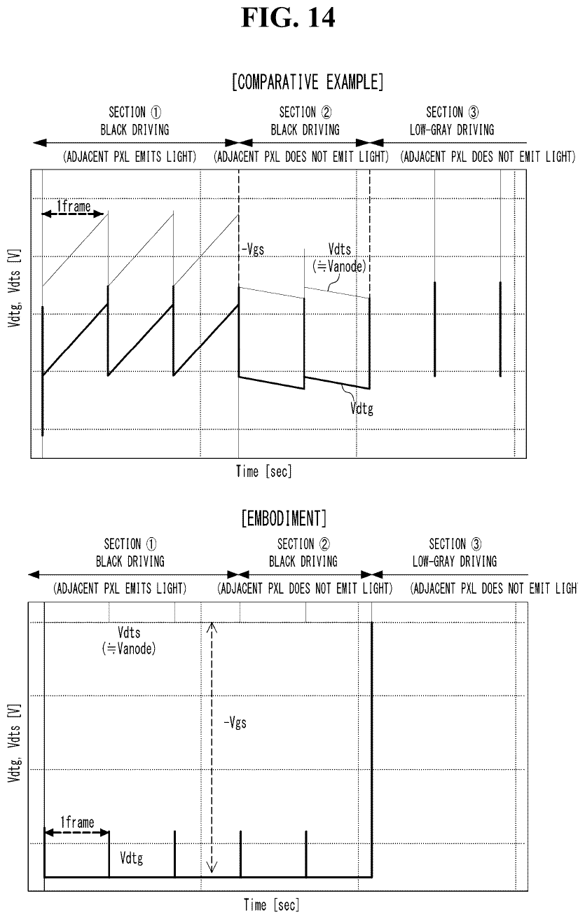

FIGS. 13 and 14 are graphs each illustrating a result of simulating changes in a gate node voltage and a source node (anode) voltage of a driving transistor during black driving of each of a display device according to an example embodiment of the present disclosure and a display device according to a comparative example.

FIG. 13 is a result of simulating changes in the gate node voltage and the source node (anode) voltage of the driving transistor when the display device to which the subpixel illustrated in FIGS. 9 and 10 is applied and the display device according to the comparative example are driven with black data under the same conditions.

As shown in FIG. 13, a first section \textcircled{1} is a section in which a measurement target pixel is driven in black and an adjacent pixel emits light. A second section \textcircled{2} is a section in which the measurement target pixel is driven in black and the adjacent pixel does not emit light, and in which the source node voltage Vdts is approximately equal to the anode voltage Vanode. A third section \textcircled{3} is a section in which the measurement target pixel is driven in low-gray and the adjacent pixel does not emit light.

As shown in the graph of the comparative example, it can be seen that a gate node voltage Vdtg and a source node voltage Vdts of the display device according to the comparative example are unstable in each frame and the gate node voltage Vdtg and the source node voltage Vdts fluctuate even within the same section over time. In addition, since a difference between the gate node voltage Vdtg and the source node voltage Vdts shows a characteristic of +Vgs during black driving, the driving transistor may be turned on during black driving and the light emitting diode OLED may be driven depending on a threshold voltage (Vth) of the driving transistor.

On the other hand, as shown in the graph according to the example embodiment, it is possible to confirm that the gate node voltage Vdtg and the source node voltage Vdts are maintained at constant values in all sections, and a difference between the gate node voltage Vdtg and the source node voltage Vdts is stably maintained at −Vgs.

Through the above simulation results, it can be seen that the display device according to the example embodiment of the present disclosure may stably reproduce black during black data driving.

FIG. 14 is a result of simulating changes in the gate node voltage and the source node (anode) voltage of the driving transistor when the display device to which the subpixel illustrated in FIGS. 11 and 12 are applied and the display device according to the comparative example are driven with black data under the same conditions.

As shown in FIG. 14, a first section \textcircled{1} is a section in which the measurement target pixel is driven in black and the adjacent pixel emits light. A second section \textcircled{2} is a section in which the measurement target pixel is driven in black and the adjacent pixel does not emit light. A third section \textcircled{3} is a section in which the measurement target pixel is driven in low-gray and the adjacent pixel does not emit light.

As shown in the graph of the comparative example, it can be seen that the gate node voltage Vdtg and the source node voltage Vdts of the display device according to the comparative example are unstable in each frame, and the gate node voltage Vdtg and source node voltage Vdts fluctuate even within the same section over time.

On the other hand, as shown in the graph according to the example embodiment, it is possible to confirm that the gate node voltage Vdtg and source node voltage Vdts are maintained at a constant value in all sections, and a difference between the gate node voltage Vdtg and source node voltage Vdts is stably maintained at −Vgs.

Through the above simulation results, it may be seen that the display device according to the example embodiment of the present disclosure may stably reproduce black during black data driving.

One or more example embodiments of the present disclosure have the following effects.

The pixel circuit according to one or more embodiments of the present disclosure and the display device including the same may improve operation accuracy and stability of the pixel by initializing the anode of the light emitting element whenever the pixel is driven in black to improve initialization performance.

The pixel circuit according to one or more embodiments of the present disclosure and the display device including the same have a switch that is turned on by black data applied to the pixel and applies an initialization voltage to the anode of the light emitting element, so that the anode of the light emitting element may be initialized with a simple configuration whenever black data is input without adding a separate signal. As a result, driving stability is ensured when reproducing black data, so that image quality may be improved.

The effects of the present disclosure are not limited to those illustrated above, and the present disclosure encompasses a wider variety of effects.

Even though example embodiments of the present disclosure have been described in more detail with reference to the attached drawings, the present disclosure is not necessarily limited to these embodiments, and various modifications may be made without departing from the technical spirit of the present disclosure. Accordingly, the example embodiments disclosed in the present disclosure are not intended to limit the technical spirit of the present disclosure but to describe the technical spirit, and the scope of the technical spirit of the present disclosure is not limited by these embodiments. Therefore, it should be understood that the embodiments described above are illustrative and not restrictive in all respects. The scope of protection of the present disclosure may be interpreted by the claims, and all technical ideas within a scope equivalent thereto should be interpreted as being included in the scope of rights of the present disclosure.

What is claimed is:

1. A display device, comprising:
a light emitting element comprising an anode to which a driving current is applied and a cathode connected to a low-potential voltage line;
a driving transistor configured to generate the driving current;
a capacitor configured to store a data voltage for generating the driving current; and
an initialization transistor configured to apply an initialization voltage to the anode of the light emitting element when the data voltage is a black data voltage for driving the light emitting element in black.

2. The display device according to claim 1, wherein, when the data voltage is the black data voltage, the driving transistor is turned off not to generate the driving current, and when the driving current is not generated, the light emitting element is turned off and driven in black.

3. The display device according to claim 1, wherein the driving transistor is an n-channel transistor, and the initialization transistor is a p-channel transistor.

4. The display device according to claim 1, wherein the initialization transistor comprises:
a gate electrode configured to receive input of the data voltage;
a first electrode connected to the anode; and
a second electrode connected to the cathode.

5. The display device according to claim 1, wherein the initialization transistor comprises:
a gate electrode configured to receive input of the data voltage;
a first electrode connected to the anode; and
a second electrode connected to an initialization voltage line configured to apply the initialization voltage to the anode.

6. The display device according to claim 1, wherein the initialization transistor comprises:
a gate electrode configured to receive input of the data voltage;
a first electrode connected to the anode; and
a second electrode connected to a reference voltage line configured to apply a reference voltage to the anode.

7. The display device according to claim 1, further comprising:
a first switching transistor having a gate electrode connected to a first scan line, a first electrode connected to a first data line, and a second electrode connected to a gate node of the driving transistor;
a second switching transistor having a gate electrode connected to a second scan line, a first electrode connected to a reference voltage line, and a second electrode connected to the gate node of the driving transistor; and
a capacitor having a first electrode connected to the second electrode of the first switching transistor and the gate node of the driving transistor, and a second electrode connected to a source node of the driving transistor.

8. The display device according to claim 1, further comprising:
a first switching transistor having a gate electrode connected to a first scan line, a first electrode connected to a first data line, and a second electrode connected to a gate node of the driving transistor;
a second switching transistor having a gate electrode connected to a second scan line, a first electrode connected to a reference voltage line, and a second electrode connected to the gate node of the driving transistor;
a third switching transistor having a gate electrode connected to a third scan line and a first electrode connected to an initialization voltage line;
a first light emitting transistor having a gate electrode connected to a first light emission line, a first electrode connected to a high-potential voltage line, and a second electrode connected to a drain node of the driving transistor;
a second light emitting transistor having a gate electrode connected to a second light emission line, a first electrode connected to a source node of the driving transistor, and a second electrode connected to the anode of the light emitting element; and
a capacitor having a first electrode connected to the second electrode of the first switching transistor and the gate node of the driving transistor, and a second electrode connected to the source node of the driving transistor.

9. A display device, comprising:
a light emitting element comprising an anode to which a driving current is applied and a cathode connected to a low-potential voltage line;
a driving transistor configured to generate the driving current;
a capacitor configured to store a first data voltage for generating the driving current; and
an initialization transistor configured to be turned on based on a second data voltage and to apply an initialization voltage to the anode of the light emitting element.

10. The display device according to claim 9, wherein the initialization transistor comprises:
a gate electrode configured to receive input of the second data voltage;
a first electrode connected to the anode; and
a second electrode connected to the cathode.

11. The display device according to claim 9, wherein the initialization transistor comprises:
a gate electrode configured to receive input of the second data voltage;
a first electrode connected to the anode; and
a second electrode connected to an initialization voltage line configured to apply the initialization voltage to the anode.

12. The display device according to claim 9, wherein the initialization transistor comprises:
a gate electrode configured to receive input of the second data voltage;
a first electrode connected to the anode; and
a second electrode connected to a reference voltage line configured to apply a reference voltage to the anode.

13. A method of driving a display device, the method comprising:
a first initialization operation of initializing a gate node and a source node of a driving transistor based on a reference voltage and an initialization voltage;
a sampling operation of storing a sampling value of the driving transistor in a capacitor based on a high-potential voltage and the reference voltage;
a data writing operation of storing a data voltage in the capacitor by summing the data voltage with the sampling value stored in the capacitor;
a reset operation of initializing the source node of the driving transistor and an anode of a light emitting element based on the initialization voltage; and
a light emitting operation of causing the light emitting element to emit light based on a driving current generated from the driving transistor,
wherein the method further comprises a second initialization operation of initializing the anode of the light emitting element when the data voltage is a black data voltage for driving the light emitting element in black in the data writing operation.

14. The method according to claim 13, wherein the second initialization operation includes applying any one of a low-potential voltage, the reference voltage, and the initialization voltage to the anode of the light emitting element.
